(19) United States
(12) Patent Application Publication
(10) Pub. No.: US 2023/0187949 A1
(43) Pub. Date: Jun. 15, 2023

(54) APPARATUS AND METHOD FOR BALANCING BATTERIES CONNECTED IN PARALLEL

(71) Applicants: Hyundai Motor Company, Seoul (KR); Kia Corporation, Seoul (KR)

(72) Inventor: Jung Moon Chang, Suwon (KR)

(21) Appl. No.: 17/884,296

(22) Filed: Aug. 9, 2022

(30) Foreign Application Priority Data
Dec. 13, 2021 (KR) 10-2021-0178009

(51) Int. Cl. H02J 7/00

(52) U.S. Cl. CPC H02J 7/0019; H02J 7/00036; H02J 7/0048; H02J 7/007182

(57) ABSTRACT

An apparatus and a method for balancing batteries connected in parallel are provided. The apparatus collects States Of Charge (SOCs) of at least two or more battery packs, determines whether the at least two or more battery packs enter a balancing mode based on the collected SOCs of the at least two or more battery packs, determines a balancing control mode based on a vehicle state, when it is determined that the at least two or more battery packs enter the balancing mode, and controls a relay of at least one of the at least two or more battery packs depending on the determined balancing control mode to perform charging or discharging and performs balancing between the at least two or more battery packs.

### CROSS-REFERENCE TO RELATED APPLICATION

This application claims, under 35 U.S.C. § 119(a), the benefit of Korean Patent Application No. 10-2021-0178009, filed in the Korean Intellectual Property Office on Dec. 13, 2021, the entire contents of which are incorporated herein by reference.

### BACKGROUND

### Technical Field

Embodiments of the present disclosure relate to an apparatus and a method for balancing batteries connected in parallel.

### Description of the Related Art

Vehicles, such as buses or trucks, are often loaded with large-capacity batteries. Large-capacity batteries have been developed in the direction of increasing capacity by means of a parallel connection between battery packs. When a large-capacity battery is repaired due to a failure in a battery pack, or when the battery pack, which fails, is replaced, a State Of Charge (SOC) difference between the repaired or replaced battery pack and the battery pack previously mounted on the vehicle occurs. When relays of the battery packs between which the SOC difference occurs are closed, to be connected with each other, a relay may be damaged due to rapid generation of current.

To address such a problem, an existing technology may identify an SOC of a previous battery pack mounted on the vehicle to match SOCs between the battery pack mounted on the vehicle and the replaced or repaired battery pack, thus supplying and treating considerable battery packs in the field or charging or discharging the battery packs between which the SOC difference occurs to adjust an SOC.

However, such an existing technology separately needs a time taken to equalize (balance) an SOC (a voltage) between a previous battery pack and the repaired or replaced battery pack after repairing or replacing the battery pack which fails.

### SUMMARY

Embodiments of the present disclosure have been made to solve the above-mentioned problems occurring in the existing technologies while advantages achieved by the existing technologies are maintained intact.

An exemplary embodiment of the present disclosure provides an apparatus and a method for balancing batteries connected in parallel to use a vehicle, when a State Of Charge (SOC) (or voltage) difference between battery packs connected in parallel occurs, and to equally correct an SOC between the battery packs by means of balancing.

The technical problems to be solved by the present disclosure are not limited to the aforementioned problems, and any other technical problems not mentioned herein will be clearly understood from the following description by those skilled in the art to which the present disclosure pertains.

According to an exemplary embodiment of the present disclosure, an apparatus for balancing batteries connected in parallel may include a communication device that is configured to receives States Of Charge (SOCs) of at least two or more battery packs, and a processing device electrically connected with the detection device. The processing device may be configured to determine whether the at least two or more battery packs enter a balancing mode based on the SOCs of the at least two or more battery packs, the SOCs being collected by the communication device, may be configured to determine a balancing control mode based on a vehicle state, when it is determined that the at least two or more battery packs enter the balancing mode, and may be configured to control a relay of at least one of the at least two or more battery packs depending on the determined balancing control mode to perform charging or discharging and may be configured to perform balancing between the at least two or more battery packs.

The processing device may be configured to determine whether an SOC difference between the at least two or more battery packs is greater than a first reference SOC difference, may be configured to determine whether a voltage difference between the at least two or more battery packs is greater than a first reference voltage difference, and may be configured to determine that the at least two or more battery packs enter the balancing mode, when the SOC difference is greater than the first reference SOC difference and when the voltage difference is greater than the first reference voltage difference.

The processing device may be configured to determine the balancing control mode as a charging balancing mode, when the vehicle state is a charging state, and may be configured to determine the balancing control mode as a driving balancing mode, when the vehicle state is a driving state.

The processing device may be configured to drive a relay of at least one charging target battery pack having a relatively low SOC among the at least two or more battery packs, when the charging balancing mode is determined, may be configured to calculate a necessary charging current for charging the at least one charging target battery pack, may be configured to request the calculated necessary charging current from a charger and may be configured to proceed with charging the at least one charging target battery pack, and may be configured to determine whether to end balancing between the battery packs, when the SOC of the at least one charging target battery pack reaches a first target battery capacity.

The processing device may be configured to multiply the number of charging target battery packs by a minimum necessary charging current to calculate the necessary charging current.

The processing device may be configured to request the charger to control the charging current to a predetermined reference current or less, when it is determined that the balancing between the battery packs is ended, may be configured to drive relays of the other battery packs, the charging of which is excluded, except for the at least one charging target battery pack among the at least two or more battery packs, when the charging current decreases to the reference current or less, and may be configured to end the balancing between the battery packs, when it is identified that the relays of the other battery packs, the charging of which is excluded, are driven.

The processing device may be configured to drive a relay of at least one discharging target battery pack having a relatively high SOC among the at least two or more battery packs, when the driving balancing mode is determined, may be configured to calculate a vehicle charging and discharging output by the at least one discharging target battery pack, may be configured to transmit the calculated vehicle charging and discharging output to a vehicle main controller, may be configured to control discharging of the at least one discharging target battery pack under an instruction of the vehicle main controller, and may be configured to determine whether to end the balancing between the at least two or more battery packs, when the SOC of the at least one discharging target battery pack reaches a second target battery capacity.

The processing device may be configured to select a minimum charging and discharging output of the at least one discharging target battery pack and may be configured to multiply the selected minimum charging and discharging output by the number of discharging target battery packs to calculate the vehicle charging and discharging output.

The processing device may be configured to determine whether a discharging current of a vehicle is less than or equal to a reference current, when it is determined that the balancing between the battery packs is ended, may be configured to drive relays of the other battery packs, the discharging of which is excluded, except for the at least one discharging target battery pack among the at least two or more battery packs, when the discharging current is less than or equal to the reference current, and may be configured to end the balancing between the at least two or more battery packs, when it is identified that the relays of the other battery packs, the discharging of which is excluded, are driven.

The processing device may be configured to perform discharging of the at least one discharging target battery pack again, when a voltage difference between the at least two or more battery packs by a cell voltage deviation is greater than or equal to a second reference voltage difference when the SOC of the at least one discharging target battery pack reaches the second target battery capacity.

According to another aspect of the present disclosure, a method for balancing batteries connected in parallel may include collecting states of charge (SOCs) of at least two or more battery packs, determining whether the at least two or more battery packs enter a balancing mode based on the collected SOCs of the at least two or more battery packs, determining a balancing control mode based on a vehicle state, when it is determined that the at least two or more battery packs enter the balancing mode, and controlling a relay of at least one of the at least two or more battery packs depending on the determined balancing control mode to perform charging or discharging and performing balancing between the at least two or more battery packs.

The determining of whether the at least two or more battery packs enter the balancing mode may include determining whether an SOC difference between the at least two or more battery packs is greater than a first reference SOC difference, determining whether a voltage difference between the at least two or more battery packs is greater than a first reference voltage difference, and determining that the at least two or more battery packs enter the balancing mode, when the SOC difference is greater than the first reference SOC difference and when the voltage difference is greater than the first reference voltage difference.

The determining of the balancing control mode may include determining the balancing control mode as a charging balancing mode, when the vehicle state is a charging state and determining the balancing control mode as a driving balancing mode, when the vehicle state is a driving state.

The performing of the balancing between the at least two or more battery packs may include driving a relay of at least one charging target battery pack having a relatively low SOC among the at least two or more battery packs, when the charging balancing mode is determined, calculating a necessary charging current for charging the at least one charging target battery pack, requesting the calculated necessary charging current from a charger and proceeding with charging the at least one charging target battery pack, and determining whether to end the balancing between the battery packs, when the SOC of the at least one charging target battery pack reaches a first target battery capacity.

The calculating of the necessary charging current may include multiplying the number of charging target battery packs by a minimum necessary charging current to calculate the necessary charging current.

The performing of the balancing between the at least two or more battery packs may further include requesting the charger to control the charging current to a predetermined reference current or less, when it is determined that the balancing between the battery packs is ended, driving relays of the other battery packs, the charging of which is excluded, except for the at least one charging target battery pack among the at least two or more battery packs, when the charging current decreases to the reference current or less, and ending the balancing between the battery packs, when it is identified that the relays of the other battery packs, the charging of which is excluded, are driven.

The performing of the balancing between the at least two or more battery packs may include driving a relay of at least one discharging target battery pack having a relatively high SOC among the at least two or more battery packs, when the driving balancing mode is determined, calculating a vehicle charging and discharging output by the at least one discharging target battery pack, transmitting the calculated vehicle charging and discharging output to a vehicle main controller, controlling discharging of the at least one discharging target battery pack under an instruction of the vehicle main controller, and determining whether to end the balancing between the at least two or more battery packs, when the SOC of the at least one discharging target battery pack reaches a second target battery capacity.

The calculating of the vehicle charging and discharging output may include selecting a minimum charging and discharging output of the at least one discharging target battery pack and multiplying the selected minimum charging and discharging output by the number of discharging target battery packs to calculate the vehicle charging and discharging output.

The performing of the balancing between the at least two or more battery packs may further include determining whether a discharging current of a vehicle is less than or equal to a reference current, when it is determined that the balancing between the battery packs is ended, driving relays of the other battery packs, the discharging of which is excluded, except for the at least one discharging target battery pack among the at least two or more battery packs, when the discharging current is less than or equal to the reference current, and ending the balancing between the at least two or more battery packs, when it is identified that the relays of the other battery packs, the discharging of which is excluded, are driven.

The determining of whether to end the balancing between the at least two or more battery packs may include performing discharging of the at least one discharging target battery pack again, when a voltage difference between the at least two or more battery packs by a cell voltage deviation is greater than or equal to a second reference voltage difference when the SOC of the at least one discharging target battery pack reaches the second target battery capacity.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a configuration of a battery system according to embodiments of the present disclosure;

FIG. 2 is a block diagram illustrating a configuration of a battery balancing device according to embodiments of the present disclosure;

FIG. 3A is a drawing illustrating a state where a voltage difference between battery packs, associated with the present disclosure, is normal;

FIG. 3B is a drawing illustrating a voltage unbalance state between battery packs associated with the present disclosure;

FIG. 3C is a drawing illustrating a problem situation due to voltage unbalance between battery packs associated with the present disclosure;

FIG. 4 is a drawing illustrating a change in battery State Of Charge (SOC) due to battery balancing upon charging according to embodiments of the present disclosure;

FIG. 5 is a drawing illustrating a change in battery SOC due to battery balancing while driving according to embodiments of the present disclosure;

FIG. 6 is a flowchart illustrating a method for determining to enter a balancing mode according to embodiments of the present disclosure;

FIG. 7 is a flowchart illustrating a battery balancing method upon charging according to embodiments of the present disclosure; and

FIG. 8 is a flowchart illustrating a battery balancing method while driving according to embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Furthermore, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

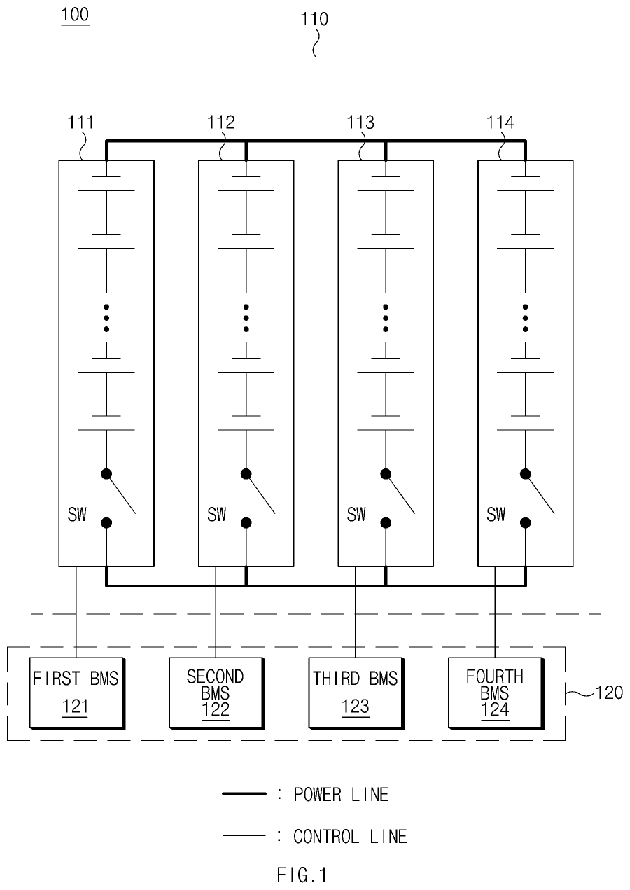

FIG. 1 is a drawing illustrating a configuration of a battery system according to embodiments of the present disclosure.

A battery system 100 may be loaded into an electrification vehicle, such as an Electric Vehicle (EV), a Plug-in Hybrid Electric Vehicle (PHEV), and/or a Hybrid Electric Vehicle (HEV), which travels using an electric motor. Referring to FIG. 1, the battery system 100 may include a battery 110 and a Battery Management System (BMS) 120.

The battery 110 may include at least two or more battery packs 111 to 114 connected in parallel. The battery 110 is disclosed as being composed of the four battery packs 111 to 114 on the drawing, but not limited thereto. It is possible to change a design of the battery 110. Each battery pack 111, 112, 113, or 114 may be composed of multiple cells. A switching element, SW, may be included in each battery pack 111, 112, 113, or 114. The switching element, SW, may perform a function of shielding a high-voltage connection. A switch, a relay, an Intelligent Power Device (IPD), a Metal Oxide Semiconductor Field Effect Transistor (MOSFET), or the like may be used as the switching element SW.

The BMS 120 may monitor a cell voltage, a cell current, a cell temperature, a cell State Of Charge (SOC), and the like using sensors mounted on the battery 110. The BMS 120 may control a voltage, a current, an output, a temperature, cell balancing, the switching element SW, and the like of the battery 110.

The BMS 120 may include a first BMS 121, a second BMS 122, a third BMS 123, and a fourth BMS 124 respectively matched with the at least two or more battery packs 111 to 114, for example, the first battery pack 111, the second battery pack 112, the third battery pack 113, and the fourth battery pack 114.

The BMS 120 may include a master BMS and at least two or more slave BMSs. Herein, the master BMS may be one of at least two or more BMSs, for example, the first BMS 121, the second BMS 122, the third BMS 123, and the fourth battery pack 114, and the slave BMSs may be the other BMSs. For example, when the first BMS 121 is the master BMS, the second BMS 122, the third BMS 123, and the fourth BMS 124 may operate as slave BMSs. The master BMS may be configured to collect and monitor pieces of driving information of the slave BMSs and may be configured to control the overall operation of the battery system 100.

The above-mentioned embodiment describes that one of the first battery pack 111, the second battery pack 112, the third battery pack 113, or the fourth battery pack 114 serves as the master BMS, but not limited thereto. A master BMS may be separately provided.

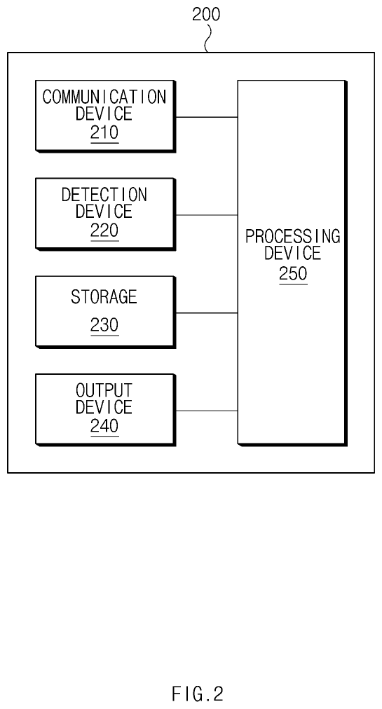

FIG. 2 is a block diagram illustrating a configuration of a battery balancing device according to embodiments of the present disclosure.

A battery balancing device 200 may be configured to control balancing between at least two or more battery packs 111 to 114 of FIG. 1. The battery balancing device 200 may serve as a master BMS. Referring to FIG. 2, the battery balancing device 200 may include a communication device 210, a detection device 220, a storage 230, an output device 240, and a processing device 250.

The communication device 210 may be configured to support communication between the battery balancing device 200 and an external device. The external device may be a slave BMS, an Electronic Control Unit (ECU) mounted on a vehicle, a vehicle main controller (e.g., a Hybrid Control Unit (HCU) or the like), and/or the like. The communication device 210 may be configured to use a vehicle communication technology, such as a Controller Area Network (CAN), a Media Oriented Systems Transport (MOST) network, a Local Interconnect Network (LIN), an Ethernet, and/or an X-by-Wire (Flexray).

The detection device 220 may be configured to measure a current, a voltage (or a cell voltage), a temperature (or a cell temperature), and the like of each battery pack using a current sensor, a voltage sensor, a temperature sensor, and the like mounted on each of the at least two or more battery packs 110. The detection device 220 may be configured to transmit the measured pieces of sensor data in the storage 230 or may transmit the measured pieces of sensor data to the processing device 250.

The storage 230 may be configured to store information (or data) received through the communication device 210 and data and the like transmitted from the detection device 220. The storage 230 may be configured to store balancing control logic, setting information, and the like. The storage 230 may be a non-transitory storage medium which may be configured to store instructions executed by the processing device 250. The storage 230 may include at least one of storage media such as a random access memory (RAM), a static RAM (SRAM), a read only memory (ROM), a programmable ROM (PROM), an electrically erasable and programmable ROM (EEPROM), an erasable and programmable ROM (EPROM), a hard disk drive (HDD), a solid state disk (SSD), an embedded multimedia card (eMMC), and/or a universal flash storage (UFS).

The output device 240 may be configured to output a progress state, a progress result, and the like according to the operation of the processing device 250. The output device 240 may include at least one of display devices such as a liquid crystal display (LCD), a thin film transistor-liquid crystal display (TFT-LCD), an organic light-emitting diode (OLED) display, a flexible display, a three-dimensional (3D) display, a transparent display, a head-up display (HUD), a touch screen, and a cluster. The output device 240 may include at least one of sound devices such as a receiver, a speaker, and a buzzer.

The processing device 250 may be electrically connected with the respective components 210 to 240. The processing device 250 may be configured to control the components 210 to 240 to control the overall operation of the battery balancing device 200. The processing device 250 may include at least one of processing devices such as an application specific integrated circuit (ASIC), a digital signal processor (DSP), programmable logic devices (PLD), field programmable gate arrays (FPGAs), a central processing unit (CPU), microcontrollers, and/or microprocessors.

The processing device 250 may be configured to receive a request for starting from the vehicle main controller. When the request for starting is received, the processing device 250 may be configured to obtain SOCs of the two or more battery packs 110. The processing device 250 may be configured to receive an SOC of the battery pack, which is transmitted from a slave BMS through the communication device 210.

The processing device 250 may be configured to determine whether the at least two or more battery packs 110 meet a balancing mode entry condition. The processing device 250 may be configured to determine whether an SOC difference and a voltage difference between the battery packs are greater than a predetermined reference SOC difference (e.g., 5%) and a predetermined reference voltage difference (e.g., 10 V), respectively. The reference SOC and the reference voltage may vary with battery specifications and vehicle specifications.

When the at least two or more battery packs 110 meet the balancing mode entry condition, the processing device 250 may be configured to enter a balancing mode. When the SOC difference and the voltage difference between the battery packs are greater than the predetermined reference SOC and the predetermined reference voltage, respectively, the processing device 250 may be configured to start balancing between the battery packs.

After entering the balancing mode, the processing device 250 may be configured to determine whether the vehicle is in a charging state or a driving state. For example, when the vehicle is connected with a charger, the processing device 250 may be configured to determine that the vehicle is in the charging state. The processing device 250 may be configured to determine that the vehicle is in the driving state based on a gear position, a speed, and/or the like of the vehicle.

When the vehicle is in the charging state, the processing device 250 may be configured to determine a balancing control mode as a charging balancing mode. When the vehicle is in the driving state, the processing device 250 may be configured to determine the balancing control mode as a driving balancing mode.

When the balancing control mode is determined as the charging balancing mode, the processing device 250 may be configured to select at least one of the at least two or more battery packs 110 as a charging target (or a charging target battery pack). The processing device 250 may be configured to select a battery pack having a relatively low SOC among the at least two or more battery packs 110 as a charging target battery pack. As an example, the processing device 250 may be configured to calculate an average SOC of the at least two or more battery packs 110 and may be configured to select a battery pack, in which a difference with the calculated average SOC is less than a reference SOC difference, among the at least two or more battery packs 110 as a charging target. The processing device 250 may be configured to switch a relay of the charging target battery pack from an open state to a closed state to proceed with charging. At this time, a relay of a battery pack excluded from the charging target (or a battery pack in which charging is excluded) may be configured to maintain the open state.

The processing device 250 may be configured to calculate a charging current (or a necessary charging current) necessary to charge the charging target battery pack based on the number of charging target battery packs when entering the charging balancing mode. The processing device 250 may be configured to multiply a minimum necessary charging current by the number of charging target battery packs to calculate the necessary charging current.

The processing device 250 may be configured to monitor an SOC deviation (or an SOC difference) and a voltage deviation (or a voltage difference) between the at least two or more battery packs 110. The processing device 250 may be configured to determine whether to end the balancing mode (i.e., whether to end balancing) based on the result of monitoring the SOC deviation and the voltage deviation between the at least two or more battery packs 110. In detail, when the SOC deviation and the voltage deviation between the at least two or more battery packs 110 are less than a predetermined reference SOC deviation (e.g., 1%) and a predetermined reference voltage deviation (e.g., 2 V), respectively, the processing device 250 may be configured to determine that the balancing mode is ended.

When it is determined that the balancing mode is ended, the processing device 250 may be configured to request a charger (not shown) to adjust the charging current to a predetermined reference charging current (e.g., 2 A) or less. The processing device 250 may be configured to switch a relay of the battery pack, the charging of which is excluded, from an open state to a closed state. When the relay of the battery pack, the charging of which is excluded, switches to the closed state, the processing device 250 may be configured to end the balancing mode. Thereafter, the charger (not shown) may be configured to control the charging current to a normal charging current. In other words, the charger may be configured to supply a charging current (or a normal charging current) necessary to charge the at least two or more battery packs 110.

When the balancing control mode is determined as the driving balancing mode, the processing device 250 may be configured to select at least one of the at least two or more battery packs 110 as a discharging target (or a discharging target battery pack). As an example, the processing device 250 may be configured to calculate an average SOC of the at least two or more battery packs 110. The processing device 250 may be configured to select a battery pack, the SOC of which is higher than the average SOC, among the at least two or more battery packs 110 as a discharging target battery pack. The processing device 250 may be configured to switch a relay of the discharging target battery pack from an open state to a closed state. At this time, a relay of a battery pack excluded from the charging target (or a battery pack, the discharging of which is excluded) may be configured to maintain the open state. After the relay of the discharging target battery pack switches to the closed state, the processing device 250 may start to drive depending on a vehicle starting procedure.

When starting to drive, the processing device 250 may be configured to enter the driving balancing mode. The processing device 250 may be configured to deactivate diagnosis of a current difference (or deviation) between the battery packs. The processing device 250 may be configured to calculate a charging and discharging output of the vehicle. The processing device 250 may be configured to multiply the number of discharging target battery packs by a minimum charging and discharging output to calculate the charging and discharging output. The processing device 250 may be configured to transmit the calculated charging and discharging output to the vehicle main controller. The vehicle main controller may be configured to control operations of devices which use electrical energy in the vehicle based on the received charging and discharging output.

The processing device 250 may be configured to monitor an SOC deviation and a voltage deviation between the two or more battery packs 110 in the driving balancing mode. In other words, the processing device 250 may be configured to compare an SOC and a voltage of the discharging target battery pack with an SOC and a voltage of the battery pack, the discharging of which is excluded. When the SOC deviation and the voltage deviation between the at least two or more battery packs 110 are less than the reference SOC deviation and the reference voltage deviation, respectively, the processing device 250 may be configured to determine that the balancing mode is ended.

When the vehicle is stopped after it is determined that the balancing mode is ended, the processing device 250 may be configured to determine whether the discharging current of the discharging target battery pack is less than or equal to a predetermined reference current (e.g., 2 A). When the discharging current is less than or equal to the reference current, the processing device 250 may be configured to switch a relay of the battery pack, the discharging of which is excluded, from an open state to a closed state. When the relay of the battery pack, the discharging of which is excluded, switches from the open state to the closed state, the processing device 250 may be configured to end the balancing mode. The processing device 250 may be configured to control a charging and discharging output (or a normal charging and discharging output) by the at least two or more battery packs 110.

As another embodiment, in a situation where two or more battery packs exceed a reference SOC difference between the battery packs in a state where three or more battery packs are connected in parallel, the processing device 250 may be configured to determine priorities based on SOCs of the battery packs to execute battery balancing. Upon charging, the processing device 250 may be configured to perform charging of battery packs in an order where the SOCs are lower. In other words, the processing device 250 may be configured to first charge a battery pack having a minimum SOC among the battery packs and may be configured to then charge a battery pack having a next low SOC. Upon driving (discharging), the processing device 250 may be configured to sequentially discharge a battery pack having a high SOC. In other words, the processing device 250 may be configured to first discharge a battery pack having a maximum SOC among the battery packs and may be configured to then discharge a battery pack having a next high SOC.

As another embodiment, when the SOC difference between the battery packs is less than the reference SOC difference, but when a voltage difference between the battery packs occurs due to a cell voltage deviation, the processing device 250 may be configured to recognize an SOC difference due to the cell voltage deviation and may be configured to operate a relay of the battery pack when the voltage difference between the battery packs enters a reference difference. When the SOC difference between the battery packs is less than the reference SOC difference, but when the voltage difference between the battery packs is not less than the reference voltage difference, the processing device 250 may be configured to identify whether the voltage difference between the battery packs is a voltage difference between the battery packs due to the cell voltage deviation. When the voltage difference between the battery packs is the voltage difference between the battery packs due to the cell voltage deviation, the processing device 250 may be configured to control a relay of the battery pack, the voltage difference of which occurs, to charge or discharge the battery pack again.

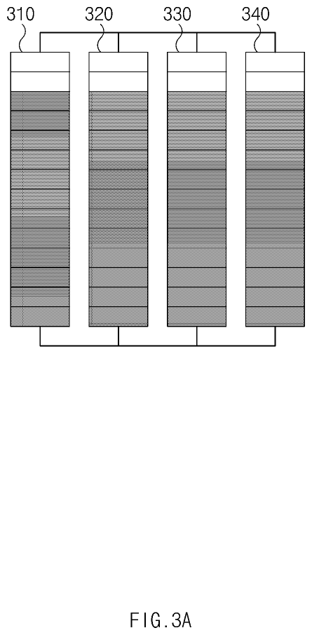

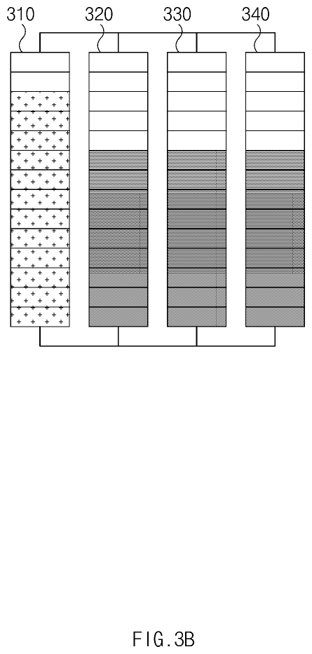

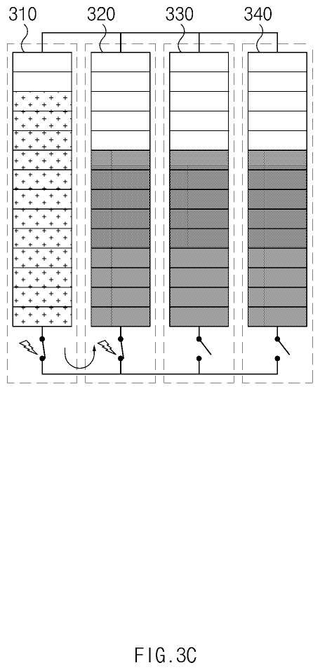

Hereinafter, a description will be given of a problem due to voltage unbalance between battery packs using FIGS. 3A to 3C.

FIG. 3A is a drawing illustrating a state where a voltage difference between battery packs associated with the present disclosure is normal. FIG. 3B is a drawing illustrating a voltage unbalance state between battery packs associated with the present disclosure. FIG. 3C is a drawing illustrating a problem situation due to voltage unbalance between battery packs associated with the present disclosure.

Referring to FIG. 3A, SOCs of a first battery pack 310, a second battery pack 320, a third battery pack 330, and a fourth battery pack 340, which are connected in parallel, are uniform. At this time, a BMS may switch relays of all the battery packs 310 to 340 from an open state to a closed state and may be configured to supply power necessary for driving of a vehicle.

Referring to FIG. 3B, when a failure occurs in the first battery pack 310 among the battery packs 310 to 340, a relay of the first battery pack 310 may switch from a closed state to an open state. Thereafter, the vehicle may use power supplied from the other second to fourth battery packs 320 to 340 except for the first battery pack 310. As such, because the vehicle travels using power supplied from the second to fourth battery packs 320 to 340, a voltage deviation between the first to fourth battery packs 310 to 340 occurs because SOCs of the second to fourth battery packs 320 to 340 are lowered.

Referring to FIG. 3C, after the first battery pack 310, which failed, is repaired (or replaced), the relay of the first battery pack 310 may be configured to switch to the closed state. At this time, a relay of at least one of the second battery pack 320, the third battery pack 330, or the fourth battery pack 340 may be damaged due to rapid voltage equalization between the first battery pack 310 and the second to fourth battery packs 320 to 340. In other words, because an inrush current due to a voltage difference between the first battery pack 310 and the second battery pack 320 flows excessively, relays of the first battery pack 310 and the second battery pack 320 may be damaged.

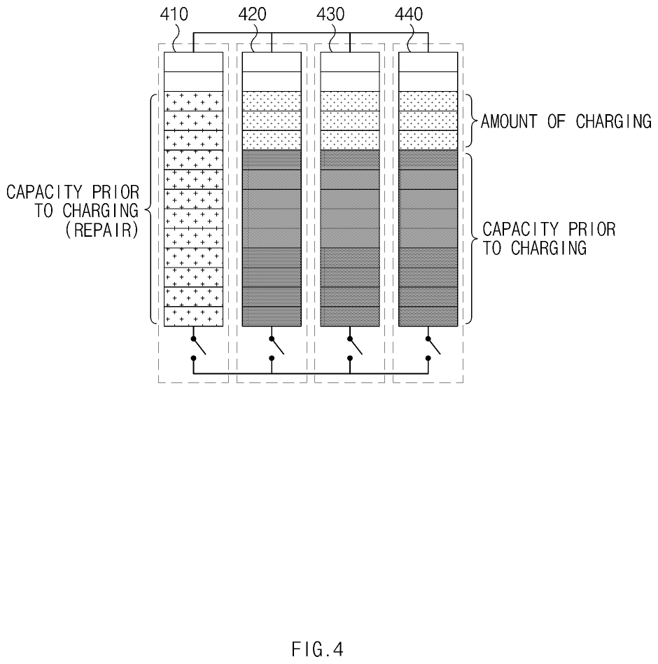

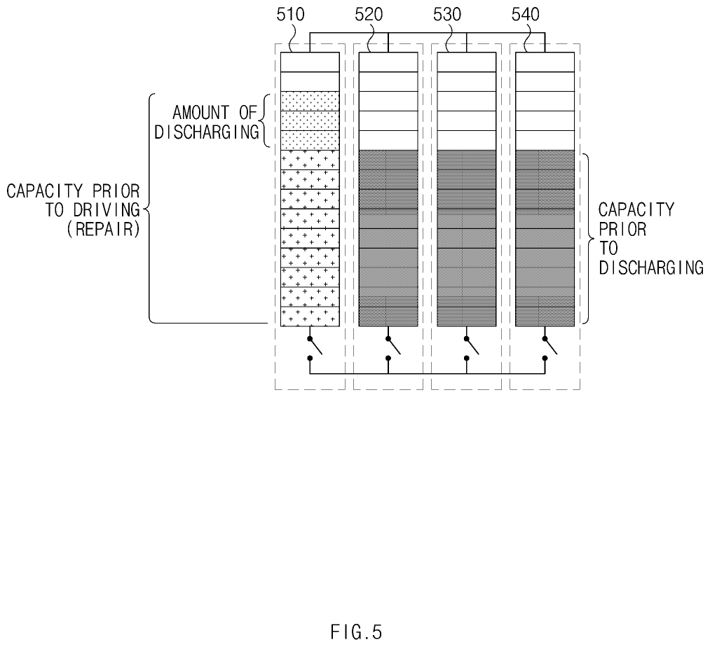

FIG. 4 is a drawing illustrating a change in battery SOC due to battery balancing upon charging according to exemplary embodiments of the present disclosure. FIG. 5 is a drawing illustrating a change in battery SOC due to battery balancing while driving according to exemplary embodiments of the present disclosure.

Referring to FIG. 4, after the first battery pack 410 fails and is repaired, when attempting to charge the first battery pack 410, a processing device 250 of a battery balancing device 200 shown in FIG. 2 may be configured to check SOCs of battery packs 410 to 440 which are before being charged, that is, having remaining battery capacities. The processing device 250 may be configured to drive relays of the second to fourth battery packs 420 to 440, each of which has a relatively lower battery SOC than the first battery pack 410, to proceed with charging. The processing device 250 may charge the second to fourth battery packs 420 to 440 until SOCs of the second to fourth battery packs 420 to 440 reach an SOC of the first battery pack 410. When the SOCs of the second to fourth battery packs 420 to 440 reach the SOC of the first battery pack 410, the processing device 250 may be configured to end balancing between the battery packs 410 to 440.

Referring to FIG. 5, after the first battery pack 510 fails and is repaired, when the vehicle starts to drive, the processing device 250 may be configured to check SOCs of battery packs 510 to 540 when the vehicle drives. The processing device 250 may be configured to select the first battery pack 510, which has a relatively large remaining battery capacity among the battery packs 510 to 540, as a discharging target. The processing device 250 may be configured to drive a relay of the first battery pack 510 selected as the discharging target to proceed with discharging. The processing device 250 may be configured to supply power to the vehicle by means of the discharging of the first battery pack 510. When the SOC of the first battery pack 510 reaches SOCs of the second to fourth battery packs 520 to 540, the processing device 250 may be configured to drive relays of the second to fourth battery packs 520 to 540 to end balancing between the battery packs 510 to 540.

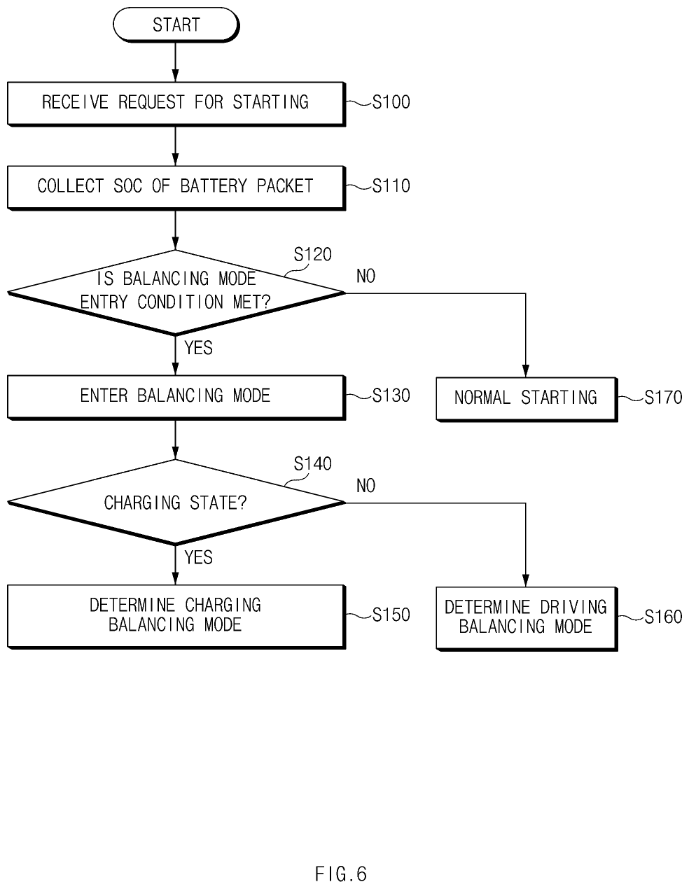

FIG. 6 is a flowchart illustrating a method for determining to enter a balancing mode according to exemplary embodiments of the present disclosure.

Referring to FIG. 6, in S100, a processing device 250 of FIG. 2 may be configured to receive a request for starting through a communication device 210 of FIG. 2. The request for starting may be a signal generated by manipulation of a start button of a user or a control signal transmitted from a vehicle main controller.

In S110, the processing device 250 may be configured to collect SOCs of at least two or more battery packs 110 loaded into a vehicle. The processing device 250 may be configured to receive SOCs of first to fourth battery packs 111 to 114 of FIG. 1, which are transmitted from first to fourth BMSs 121 to 124 of FIG. 1, using the communication device 210. The processing device 250 may be configured to directly detect SOCs of first to fourth battery packs 111 to 114 by means of a detection device 220 of FIG. 2.

In S120, the processing device 250 may be configured to determine whether the at least two or more battery packs 110 meet a balancing mode entry condition. The processing device 250 may be configured to determine whether the at least two or more battery packs 110 meet the balancing mode entry condition based on the collected SOC information of the at least two or more battery packs 110. When an SOC deviation and a voltage deviation between the at least two or more battery packs 110 are greater than a first reference SOC deviation and a first reference voltage deviation, respectively, the processing device 250 may be configured to determine that the at least two or more battery packs 110 meet the balancing mode entry condition. When at least one of the SOC difference and the voltage difference between the at least two or more battery packs 110 is less than or equal to a reference value (i.e., the first reference SOC difference and/or the first reference voltage difference), the processing device 250 may be configured to determine that the at least two or more battery packs 110 do not meet the balancing mode entry condition.

When it is determined that the at least two or more battery packs 110 meet the balancing mode entry condition, in S130, the processing device 250 may be configured to enter a balancing mode. When the balancing mode entry condition is met, the processing device 250 may be configured to change an operation mode of a battery balancing device 200 of FIG. 2 to a balancing mode.

After entering the balancing mode, in S140, the processing device 250 may be configured to determine whether the vehicle is in a charging state. When a connection to a charging port is detected and/or when a communication start signal with a charger is received, the processing device 250 may be configured to determine to enter a charging procedure. When it is determined to enter the charging procedure, the processing device 250 may be configured to determine the vehicle state as a charging state. When it is not determined to enter the charging procedure, the processing device 250 may be configured to determine the vehicle state as a driving state.

When the vehicle is in the charging state, in S150, the processing device 250 may be configured to determine a balancing control mode as a charging balancing mode. When the charging balancing mode is determined, the processing device 250 may be configured to select at least one charging target battery pack among the at least two or more battery packs 110. The processing device 250 may be configured to select a battery pack having a relatively low battery SOC among the at least two or more battery packs 110 as a charging target battery pack. For example, the processing device 250 may be configured to select a battery pack, in which an SOC difference and a voltage difference between battery packs are less than a first reference SOC difference and a first reference voltage difference among the at least two or more battery packs 110, as a charging target.

When the vehicle is not in the charging state, in S160, the processing device 250 may be configured to determine the balancing control mode as a driving balancing mode. The processing device 250 may be configured to determine that the vehicle is in a driving state based on a gear position, a speed, a destination setting, and/or the like of the vehicle. When it is determined that the vehicle is in the driving state, the processing device 250 may be configured to determine the balancing control mode as the driving balancing mode. When the driving balancing mode is determined, the processing device 250 may be configured to select at least one of the at least two or more battery packs 110 as a discharging target battery pack. The processing device 250 may be configured to select a battery pack having a relatively high battery SOC among the at least two or more battery packs 110 as a discharging target battery pack. For example, the processing device 250 may be configured to select a battery pack, in which an SOC difference and a voltage difference between battery packs are greater than the first reference SOC difference and the first reference voltage difference among the at least two or more battery packs 110, as a discharging target.

When the balancing mode entry condition is not met in S120, in S170, the processing device 250 may be configured to perform normal starting. The processing device 250 may be configured to assist the vehicle to start depending on a predetermined starting procedure. In other words, the processing device 250 may be configured to close all relays of the at least two or more battery packs 110 to supply power necessary to drive the vehicle.

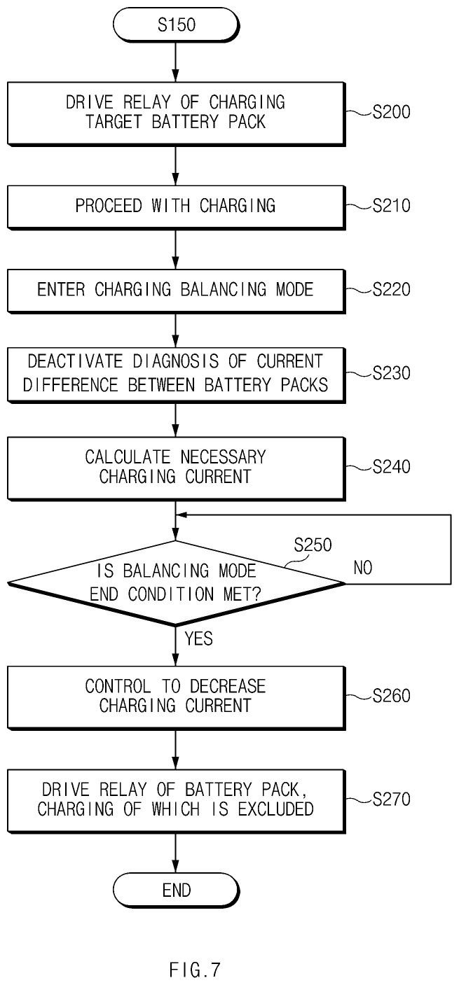

FIG. 7 is a flowchart illustrating a battery balancing method upon charging according to exemplary embodiments of the present disclosure.

In S200, a processing device 250 of FIG. 2 may be configured to drive a relay of a charging target battery pack when starting to charge a vehicle battery. The processing device 250 may be configured to switch a relay of the charging target battery pack from an open state to a closed state.

When the relay of the charging target battery pack is driven, in S210, the processing device 250 may be configured to proceed with charging the charging target battery pack. The processing device 250 may be configured to close the relay of the charging target battery pack and may be configured to connect a path of a charging current to proceed with charging.

In S220, the processing device 250 may be configured to enter a driving balancing mode, while proceeding with the charging.

In S230, the processing device 250 may be configured to deactivate diagnosis of a current difference between battery packs.

In S240, the processing device 250 may be configured to calculate a charging current (or a necessary charging current) necessary to charging the charging target battery pack. The processing device 250 may be configured to multiply the number of charging target battery packs by a minimum necessary charging current to calculate the necessary charging current. The processing device 250 may be configured to request the calculated necessary charging current from a charger. The charger may be configured to supply the necessary charging current to charge the charging target battery pack depending on the request of the processing device 250.

In S250, the processing device 250 may be configured to determine whether a balancing mode end condition is met. The processing device 250 may be configured to compare an SOC and a voltage of the charging target battery pack with an SOC and a voltage of a battery pack excluded from the charging target (or a battery pack, the charging of which is excluded). The processing device 250 may be configured to determine whether the balancing mode end condition is met based on the compared result. The processing device 250 may be configured to determine whether differences between the SOC and the voltage of the charging target battery pack and the SOC (or a target battery capacity) and the voltage of the battery pack, the charging of which is excluded, are less than a predetermined second reference SOC difference and a predetermined second reference voltage difference, respectively. When the SOC difference and the voltage difference are less than the second reference SOC difference and the second reference voltage difference, respectively, the processing device 250 may be configured to determine that the balancing mode is ended. In other words, when the SOC of the charging target battery pack reaches the SOC of the battery pack, the charging of which is excluded, the processing device 250 may be configured to determine that the balancing mode is ended. When at least one of the SOC difference or the voltage difference is greater than or equal to a reference value (or the second reference SOC difference or the second reference voltage difference) as a result of the comparison, the processing device 250 may be configured to additionally proceed with charging the charging target battery pack. When the SOC difference is less than the second reference SOC difference, or the voltage difference is greater than or equal to the second reference voltage as a result of the comparison, the processing device 250 may be configured to decrease a target battery capacity with regard to an SOC error to reattempt to charge the charging target battery pack.

When the balancing mode end condition is met, in S260, the processing device 250 may be configured to control to reduce/decrease a charging current. When it is determined that the balancing mode is ended, the processing device 250 may be configured to request a charger to control a charging current to a predetermined reference current or less.

In S270, the processing device 250 may be configured to drive a relay of the battery pack, the charging of which is excluded. The processing device 250 may be configured to switch a relay of the battery pack, the charging of which is excluded, from an open state to a closed state to charge the battery pack, the charging of which is excluded. In other words, when the SOC of the charging target battery pack reaches the SOC of the battery pack, the charging of which is excluded, the processing device 250 may be configured to control to charge all battery packs including the battery pack, the charging of which is excluded.

Thereafter, when the relay of the battery pack, the charging of which is excluded, is driven, the processing device 250 may be configured to end the balancing mode. The processing device 250 may be configured to request the charger to control a charging current for charging all battery packs.

According to the above-mentioned embodiment, a battery balancing device 200 of FIG. 2 may be configured to proceed with charging only a battery pack having a relatively low SOC among battery packs upon charging. When an SOC of a battery pack having a low SOC reaches an SOC equivalent to that of a battery pack having a high SOC, the battery balancing device 200 may be configured to drive all relays of battery packs to normalize battery driving.

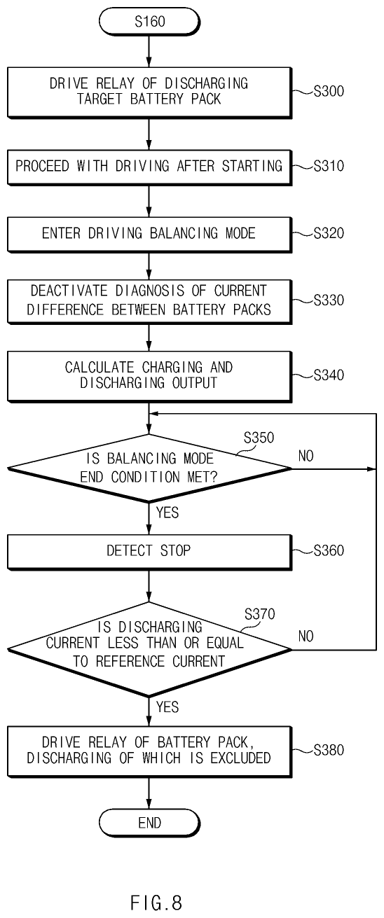

FIG. 8 is a flowchart illustrating a battery balancing method while driving according to exemplary embodiments of the present disclosure.

In S300, a processing device 250 of FIG. 2 may be configured to drive a relay of a discharging target battery pack when a vehicle starts. The processing device 250 may be configured to switch the relay of the discharging target battery pack from an open state to a closed state when the vehicle enters starting due to manipulation of a start button of a user. At this time, the processing device 250 may be configured to maintain a relay of a battery pack, the discharging of which is excluded, in the open state.

In S310, the processing device 250 may be configured to turn on the vehicle depending on a predetermined starting procedure to proceed with driving. The processing device 250 may be configured to supply power using the discharging target battery pack such that the vehicle starts to drive.

In S320, the processing device 250 may be configured to enter a driving balancing mode when the vehicle drives.

When entering the driving balancing mode, in S330, the processing device 250 may be configured to deactivate diagnosis of a current difference between battery packs.

In S340, the processing device 250 may be configured to calculate a charging and discharging output of the vehicle. When calculating the vehicle charging and discharging output, the processing device 250 may be configured to select a minimum value among charging and discharging outputs of the discharging target battery pack. The processing device 250 may be configured to multiply the selected minimum value, that is, a minimum charging and discharging output by the number of discharging battery packs to calculate the charging and discharging output of the vehicle. The processing device 250 may be configured to transmit the calculated charging and discharging output of the vehicle to a vehicle main controller. The vehicle main controller may be configured to control driving of the vehicle based on the charging and discharging output of the vehicle (or a charging and discharging output of the discharging target battery pack).

In S350, the processing device 250 may be configured to determine whether at least two or more battery packs 110 meet a balancing mode end condition based on an SOC difference and a voltage difference between the at least two or more battery packs 110. The processing device 250 may be configured to compare an SOC of the discharging target battery pack with an SOC (or a target battery capacity) of a battery pack, the discharging of which is excluded, to compare a voltage of the discharging target battery pack with a voltage of the battery pack, the discharging of which is excluded. When the SOC difference and the voltage difference are less than a second reference SOC difference and a second reference voltage difference, respectively, as a result of the comparison, the processing device 250 may be configured to determine that the balancing mode is ended. When at least one of the SOC difference or the voltage difference is greater than or equal to a reference value (or the second reference SOC difference or the second reference voltage difference) as a result of the comparison, the processing device 250 may be configured to additionally proceed with discharging the discharging target battery pack. When the SOC difference is less than the second reference SOC difference, but the voltage difference is greater than or equal to the second reference voltage as a result of the comparison, the processing device 250 may be configured to decrease a target battery capacity with regard to an SOC error to reattempt to discharge the discharging target battery pack.

When the balancing mode end condition is met, in S360, the processing device 250 may be configured to detect a stop. The processing device 250 may be configured to recognize a stop based on a speed of the vehicle, position information of a brake pedal of the vehicle, and the like.

In S370, the processing device 250 may be configured to determine whether a discharging current is less than or equal to a reference current, when the vehicle is stopped. The processing device 250 may be configured to identify whether the discharging current of the discharging target battery pack decreases to the reference current or less.

When the discharging current is less than or equal to the reference current, in S380, the processing device 250 may be configured to drive a relay of the battery pack, the discharging of which is excluded. The processing device 250 may be configured to switch the relay of the battery pack, the discharging of which is excluded, from an open state to a closed state to use all battery packs including the battery pack, the discharging of which is excluded.

Thereafter, when the relay of the battery pack, the discharging of which is excluded, is driven, the processing device 250 may be configured to end the balancing mode. When the relay of the battery pack, the discharging of which is excluded, switches to the closed state, the processing device 250 may be configured to end the balancing mode.

According to the above-mentioned exemplary embodiment, a battery balancing device 200 of FIG. 2 may be configured to use only a battery pack having a relatively high SOC among battery packs to drive the vehicle, when the vehicle drives. When an SOC of a battery pack having a high SOC reaches an SOC equivalent to that of a battery pack having a low SOC, the battery balancing device 200 may be configured to drive all relays of battery packs to normalize battery driving.

Embodiments of the present disclosure may be configured to use a vehicle when an SOC difference between battery packs connected in parallel occurs and may be configured to correct an SOC by means of balancing between the battery packs, thus resolving the voltage difference between the battery packs without a separate voltage equalization time.

Furthermore, embodiments of the present disclosure may be configured to drive a relay in a state where it is possible to resolve a voltage difference without a separate work, when an SOC difference between battery packs occurs due to an abnormality in battery pack, thus increasing durability of the relay.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present invention are not intended to limit the technical spirit of the present invention, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for balancing batteries connected in parallel, the apparatus comprising:
a communication device configured to receive States Of Charge (SOCs) of at least two or more battery packs; and
a processing device electrically connected with a detection device,
wherein the processing device is configured to:
determine whether the at least two or more battery packs enter a balancing mode based on SOCs of the at least two or more battery packs, the SOCs being collected by the communication device,
determine a balancing control mode based on a vehicle state, when it is determined that the at least two or more battery packs enter the balancing mode, and
control a relay of at least one of the at least two or more battery packs depending on the determined balancing control mode to perform charging or discharging and performs balancing between the at least two or more battery packs.

2. The apparatus of claim 1, wherein the processing device is further configured to:
determine whether an SOC difference between the at least two or more battery packs is greater than a first reference SOC difference,
determine whether a voltage difference between the at least two or more battery packs is greater than a first reference voltage difference, and
determine that the at least two or more battery packs enter the balancing mode, when the SOC difference is greater than the first reference SOC difference and when the voltage difference is greater than the first reference voltage difference.

3. The apparatus of claim 1, wherein the processing device is further configured to:
determine the balancing control mode as a charging balancing mode, when the vehicle state is a charging state, and
determine the balancing control mode as a driving balancing mode, when the vehicle state is a driving state.

4. The apparatus of claim 3, wherein the processing device is further configured to:
drive a relay of at least one charging target battery pack having a relatively low SOC among the at least two or more battery packs, when the charging balancing mode is determined,
calculate a necessary charging current for charging the at least one charging target battery pack,
request the calculated necessary charging current from a charger and proceed with charging the at least one charging target battery pack, and
determine whether to end balancing between the at least two or more battery packs, when the SOC of the at least one charging target battery pack reaches a first target battery capacity.

5. The apparatus of claim 4, wherein the processing device is further configured to multiply a number of charging target battery packs by a minimum necessary charging current to calculate the necessary charging current.

6. The apparatus of claim 4, wherein the processing device is further configured to:
request the charger to control the charging current to a predetermined reference current or less, when it is determined that the balancing between the battery packs is ended,
drive relays of other battery packs, the charging of which is excluded, except for the at least one charging target battery pack among the at least two or more battery packs, when the charging current decreases to the reference current or less, and
end the balancing between the battery packs, when it is identified that the relays of the other battery packs, the charging of which is excluded, are driven.

7. The apparatus of claim 3, wherein the processing device is further configured to:
drive a relay of at least one discharging target battery pack having a relatively high SOC among the at least two or more battery packs, when the driving balancing mode is determined,
calculate a vehicle charging and discharging output by the at least one discharging target battery pack,
transmit the calculated vehicle charging and discharging output to a vehicle main controller,
control discharging of the at least one discharging target battery pack under an instruction of the vehicle main controller, and
determine whether to end the balancing between the at least two or more battery packs, when the SOC of the at least one discharging target battery pack reaches a second target battery capacity.

8. The apparatus of claim 7, wherein the processing device is further configured to:
select a minimum charging and discharging output of the at least one discharging target battery pack, and
multiply the selected minimum charging and discharging output by a number of discharging target battery packs to calculate the vehicle charging and discharging output.

9. The apparatus of claim 7, wherein the processing device is further configured to:
determine whether a discharging current of a vehicle is less than or equal to a reference current, when it is determined that the balancing between the at least two or more battery packs is ended,
drive relays of other battery packs, the discharging of which is excluded, except for the at least one discharging target battery pack among the at least two or more battery packs, when the discharging current is less than or equal to the reference current, and
end the balancing between the at least two or more battery packs, when it is identified that the relays of the other battery packs, the discharging of which is excluded, are driven.

10. The apparatus of claim 7, wherein the processing device is further configured to perform discharging of the at least one discharging target battery pack again, when a voltage difference between the at least two or more battery packs by a cell voltage deviation is greater than or equal to a second reference voltage difference when the SOC of the at least one discharging target battery pack reaches the second target battery capacity.

11. A method for balancing batteries connected in parallel, the method comprising:
collecting States Of Charge (SOCs) of at least two or more battery packs;
determining whether the at least two or more battery packs enter a balancing mode based on collected SOCs of the at least two or more battery packs;
determining a balancing control mode based on a vehicle state, when it is determined that the at least two or more battery packs enter the balancing mode; and
controlling a relay of at least one of the at least two or more battery packs depending on the determined balancing control mode to perform charging or discharging and performing balancing between the at least two or more battery packs.

12. The method of claim 11, wherein the determining of whether the at least two or more battery packs enter the balancing mode comprises:
determining whether an SOC difference between the at least two or more battery packs is greater than a first reference SOC difference;
determining whether a voltage difference between the at least two or more battery packs is greater than a first reference voltage difference; and
determining that the at least two or more battery packs enter the balancing mode, when the SOC difference is greater than the first reference SOC difference and when the voltage difference is greater than the first reference voltage difference.

13. The method of claim 11, wherein the determining of the balancing control mode comprises:
determining the balancing control mode as a charging balancing mode, when the vehicle state is a charging state; and
determining the balancing control mode as a driving balancing mode, when the vehicle state is a driving state.

14. The method of claim 13, wherein the performing of the balancing between the at least two or more battery packs comprises:
driving a relay of at least one charging target battery pack having a relatively low SOC among the at least two or more battery packs, when the charging balancing mode is determined;
calculating a necessary charging current for charging the at least one charging target battery pack;
requesting the necessary charging current from a charger and proceeding with charging the at least one charging target battery pack; and
determining whether to end the balancing between the battery packs, when the SOC of the at least one charging target battery pack reaches a first target battery capacity.

15. The method of claim 14, wherein the calculating of the necessary charging current comprises multiplying a number of charging target battery packs by a minimum necessary charging current to calculate the necessary charging current.

16. The method of claim 14, further comprising:
requesting the charger to control the necessary charging current to a predetermined reference current or less, when it is determined that the balancing between the battery packs is ended;
driving relays of other battery packs, the charging of which is excluded, except for the at least one charging target battery pack among the at least two or more battery packs, when the charging current decreases to the reference current or less; and
ending the balancing between the battery packs, when it is identified that the relays of the other battery packs, the charging of which is excluded, are driven.

17. The method of claim 13, wherein the performing of the balancing between the at least two or more battery packs comprises:
driving a relay of at least one discharging target battery pack having a relatively high SOC among the at least two or more battery packs, when the driving balancing mode is determined;
calculating a vehicle charging and discharging output by the at least one discharging target battery pack;
transmitting the calculated vehicle charging and discharging output to a vehicle main controller;
controlling discharging of the at least one discharging target battery pack under an instruction of the vehicle main controller; and
determining whether to end the balancing between the at least two or more battery packs, when the SOC of the at least one discharging target battery pack reaches a second target battery capacity.

18. The method of claim 17, wherein the calculating of the vehicle charging and discharging output comprises:
selecting a minimum charging and discharging output of the at least one discharging target battery pack; and
multiplying the selected minimum charging and discharging output by a number of discharging target battery packs to calculate the vehicle charging and discharging output.

19. The method of claim 17, further comprising:
determining whether a discharging current of a vehicle is less than or equal to a reference current, when it is determined that the balancing between the at least two or more battery packs is ended;
driving relays of other battery packs, the discharging of which is excluded, except for the at least one discharging target battery pack among the at least two or more battery packs, when the discharging current is less than or equal to the reference current; and
ending the balancing between the at least two or more battery packs, when it is identified that the relays of the other battery packs, the discharging of which is excluded, are driven.

20. The method of claim 17, wherein the determining of whether to end the balancing between the at least two or more battery packs comprises performing discharging of the at least one discharging target battery pack again, when a voltage difference between the at least two or more battery packs by a cell voltage deviation is greater than or equal to a second reference voltage difference when the SOC of the at least one discharging target battery pack reaches the second target battery capacity.
